(19) United States
(12) Patent Application Publication
(10) Pub. No.: US 2009/0282696 A1
(43) Pub. Date: Nov. 19, 2009

(54) DRYER AND CONTROL METHOD THEREOF

(76) Inventors: Min-Ji KIM, Gyeongsangnam-do (KR); Ju-Han Yoon, Gyeongsangnam-Do (KR); Dong-Geun Lee, Gyeongsangnam-Do (KR); Chul-Jin Choi, Gyeongsangnam-Do (KR)

Correspondence Address: BIRCH STEWART KOLASCH & BIRCH, PO BOX 747, FALLS CHURCH, VA, 22040-0747, US

(21) Appl. No.: 12/465,867

(22) Filed: May 14, 2009

(30) Foreign Application Priority Data
May 15, 2008 (KR) 10-2008-0045207

(51) Int. Cl. F26B 3/02; D06F 58/04

(52) U.S. Cl. 34/493; 34/132

(57) ABSTRACT

A method for controlling a dryer includes: a steam supply step of supplying steam to the interior of a drum to create a high temperature atmosphere and sterilize a dry item housed in the drum; and a hot wind supply step of supplying hot wind to the interior of the drum to uniformly maintain the temperature at the interior of the drum. The dry items can be effectively sterilized within a short time without causing a thermal damage to the dry items, creases of the dry items can be removed, and the dry items can be deodorized.

### BACKGROUND OF THE INVENTION

1. Field of the Invention

The present invention relates to a dryer having a steam supply function and its control method, and more particularly, to a dryer capable of sterilizing a dry item such as clothes and the like without causing a thermal damage to the dry item and effectively preventing and removing rumples and creases of the dry item and deodorizing the dry item, and its control method.

2. Description of the Related Art

In general, a dryer, a home appliance that dries the laundry which has been completely washed, namely, the clothes, by using air of high temperature, includes a drum for housing dry items, a driving source for driving the drum, a heating unit for heating air introduced into the drum, and a blower unit for sucking air within the drum or discharging air from the drum.

The dryer may be classified into various types of dryers according to discrimination references. First, the dryer may be divided into an electric dryer and a gas dryer according to how air is heated, namely, according to a heating unit. The electric dryer heats air by using electric resistance heat and the gas dryer heats air by using heat generated according to combustion of gas.

Also, the dryer may be divided into a condensing type dryer and an exhaust-type dryer depending on how humid air generated while the dry item is being dried is processed. In the condensing type dryer, air which becomes humid as it is heat-exchanged with the dry item is circulated without being externally discharged, and a condenser creates condensing water by heat exchanging it with external air and discharges it to outside. In the exhaust type dryer, air which becomes humid as it is heat-exchanged with the dry item in the drum is directly discharged to outside the dryer.

In addition, the dryer may be classified into a top loading type dryer and a front loading type dryer depending on how dry items are inputted into the dryer. In the top loading type dryer, dry items are inputted from an upper side of the dryer, and in the front loading type dryer, dry items are inputted from a front side of the dryer.

In the related art dryers, dry items are dried by using air of high temperature regardless of the classification method. Thus, as the dry items are in contact with the air of high temperature for a long time, they are sterilized. Namely, under the temperature conditions that the interior of the drum of the dryer is higher than 60° C., hot wind is supplied to the dry items housed in the drum for longer than 90 minutes to sterilize the dry items.

Thus, in the related art dryer, the sterilization time taken for sterilizing the dry items housing within the dryer is long, and the dry items are exposed to the hot wind for a long time, causing a thermal damage to the dry items.

### SUMMARY OF THE INVENTION

Therefore, in order to address the above matters, the various features described herein have been conceived. One aspect of the exemplary embodiments is to provide a dryer capable of effectively sterilizing dry items such as clothes within a short time without causing a thermal damage to the dry items, and a control method of the dryer.

Another aspect of the present invention is to provide a dryer capable of removing or preventing rumples or creases already generated at a dry item as well as sterilizing the dry item, and its control method.

This specification provides a method for controlling a dryer, including: a steam supply step of supplying steam to the interior of a drum to create a high temperature atmosphere and sterilize a dry item housed in the drum; and a hot wind supply step of supplying hot wind to the interior of the drum to uniformly maintain the temperature at the interior of the drum.

This specification also provides a method for controlling a dryer, including: a steam supply step of supplying steam to the interior of a drum to create a high temperature atmosphere and sterilize a dry item housed in the drum; a cooling step of lowering the temperature maintained in the step supply step; and a hot wind supply step of supplying hot wind to the interior of the drum to uniformly maintain the temperature at the interior of the drum.

This specification also provides a method for controlling a dryer, including: inputting an operation mode of the dryer; a steam supply step of supplying steam to the interior of a drum to create a high temperature atmosphere and sterilize a dry item housed in the drum; and a hot wind supply step of supplying hot wind to the interior of the drum to uniformly maintain the temperature at the interior of the drum.

This specification also provides a dryer which includes a drum and a heater supplying hot wind to the interior of the drum and is able to supply steam to the interior of the drum, the dryer including: a controller that controls the steam supply to sterilize a dry item housed in the interior of the drum and controls the heat to uniformly maintain the temperature in the interior of the drum according to the supply of hot wind.

This specification also provides a dryer which includes a drum and a heater supplying hot wind to the interior of the drum and is able to supply steam to the interior of the drum, the dryer including: a controller panel unit that receives an operation method according to a user selection; and a controller that controls the steam supply to sterilize a dry item housed in the interior of the drum and controls the heat to uniformly maintain the temperature in the interior of the drum according to the supply of hot wind.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a sectional view of a dryer according to an embodiment of the present invention;

FIG. 2 illustrates a steam supply device of the dryer;

FIG. 3 is a block diagram of a controller of the dryer according to an embodiment of the present invention;

FIG. 4 is a flow chart illustrating a method for controlling a dryer according to an embodiment of the present invention;

FIG. 5 is a graph of the relationship between time and temperature when the dryer control method is performed in a sterilization operation mode according to an embodiment of the present invention;

FIG. 6 is a graph of the relationship between a sterilization rate and the number of steam spraying when the dryer control method is performed at the same temperature condition;

FIG. 7 is a graph of temperature over time when a hot wind supply process is performed for 15 minutes in the dryer control method according to an embodiment of the present invention;

FIG. 8 is a graph of the relationship between types of dry items and a sterilization rate when the dryer control method of FIG. 7 is performed on staphylococcus;

FIG. 9 is a graph of temperature over time when a hot wind supply process is performed for 8 minutes in the dryer control method according to an embodiment of the present invention;

FIG. 10 is a graph of the relationship between types of dry items and a sterilization rate when the dryer control method of FIG. 7 is performed on pseudomonas aeruginosa.

### DETAILED DESCRIPTION OF THE INVENTION

A dryer and its control method according to exemplary embodiments of the present invention will now be described with reference to the accompanying drawings.

In order to described the dryer according to an embodiment of the present invention, a front loading type dryer, an electric dryer, and a condensing type dryer will be described as examples. However, without being limited thereto, the present invention can be also applicable to a top loading type dryer, a gas dryer, and the like.

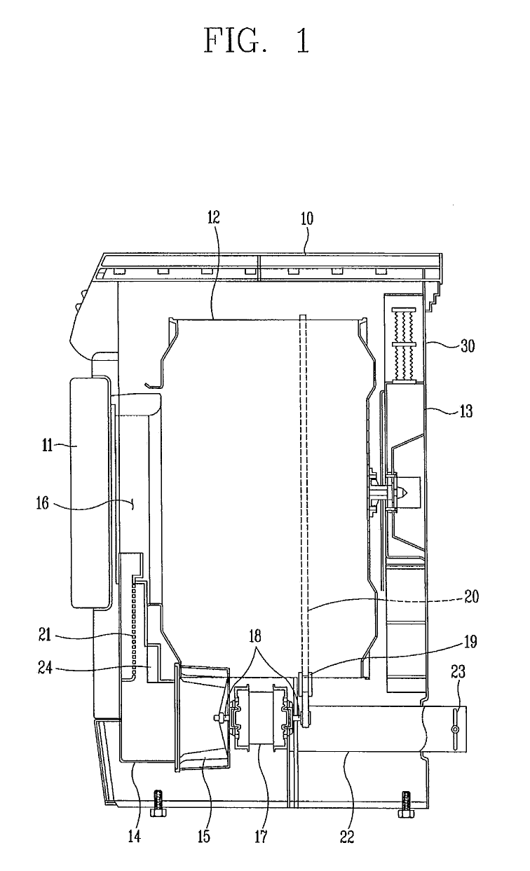

The dryer according to an embodiment of the present invention will now be described with reference to FIGS. 1 to 3.

As shown in FIG. 1 illustrating a sectional structure, the dryer includes a cabinet 10 forming an external appearance and including a door 11 formed at a front face, a drum 12 rotatably installed within the cabinet 10, a hot wind guide duct 13 for guiding hot wind to the interior of the drum 12, a hot wind exhaust duct 14 for discharging hot wind which has passed through the interior of the drum 12, a blow fan 15 for sucking external air and discharging it, and a temperature detecting unit 24 for detecting the temperature of hot wind discharged via the hot wind exhaust duct 14.

An opening 16 is formed at the front face of the cabinet 10 with the door 11, through which the laundry can be taken into the interior of the drum 12 or taken out therefrom. The drum 12 is rotated at a low speed by a motor 17 installed at a lower portion of the cabinet 10. The motor 17 is provided to simultaneously drive the drum 12 and the blow fan 15, for which, thus, a driving shaft 18 of the motor 17 extends to both sides of the motor 17. One end of the driving shaft 18 is connected to the blow fan 15, and the other end of the driving shaft 18 is connected to a pulley 19 for rotating the drum 12. A belt 20 installed to cover the drum 12 is connected to the pulley 19.

The hot wind discharge duct 14 is disposed between a lower portion of the front side of the drum 12 and the blow fan 15. A filter 21 is installed at one end of the hot wind exhaust duct 14 to filter out debris such as nap and the like included in the hot wind which has passed through the drum 12. An exhaust duct 22 formed as a cylindrical pipe and having an open end extending to outside the cabinet 10 is combined to an exit of the blow fan 15. An opening and shutting valve 23 is installed at the open end of the exhaust duct 22 to open the exhaust duct 22 by hot wind when the blow fan 15 operates, and shut the exhaust duct 22 when the blow fan 15 does not operate, to thereby prevent introduction of debris from the outside.

A heater 30 is installed at an upper portion of the hot wind guide duct 13, and as the blow fan 15 and the drum 12 are rotated according to driving of the motor 17, external air is heated while passing through the heater 30 and then introduced into the drum 12 via the hot wind guide duct 13. Accordingly, the clothes put in the drum 12 is dried by the hot wind, and the hot wind which has passed through the drum 12 is discharged to outside via the hot wind exhaust duct 14 and the exhaust duct 22.

A steam generator 200 is installed at a certain portion of the cabinet 10 to generate steam and supply it to the interior of the drum 12. The steam generator 200 will now be described with reference to FIG. 2.

The steam generator 200 supplies steam to the interior of the drum 12 to make the interior of the drum 12 have a high temperature atmosphere within a short time and sterilize the dry item housed in the drum. Also, the steam generator 200 supplies steam to prevent or remove rumples or creases of the dry items housed in the drum 12.

The steam generator 200 includes a tank 210 for housing water therein, a heater 240 mounted within the water tank 210, a water level sensor 260 for measuring a water level of the steam generator 200, and a temperature sensor 270 for measuring temperature of the steam generator 200. The water level sensor 260 generally includes a common electrode 262, a low water level electrode 264 and a high water level electrode 266, and detects a high water level or low water level according to an electrical connection between the common electrode 262 and the high water level electrode 264 and an electrical connection between the common electrode 262 and the low water level electrode 266.

A water supply hose 220 is connected to one side of the steam generator 200 to supply water, and a steam hose 230 is connected to another side of the steam generator 200 to discharge steam. In general, one end of the water supply hose 220 is connected to an external water supply source such as a faucet, and a front end portion of the steam hose 230 or a nozzle 250, i.e., a steam discharge hole, is positioned at a certain portion of the drum 12 to spray (jet) steam to the interior of the drum 12.

In this embodiment, the steam generator 200 (referred to as ‘container heating type’, hereinafter) that generates steam by heating a certain amount of water housed in the tank 210 of a certain size with the heater 240 has been described, but the present invention is not limited thereto. Namely, any device can be used as the steam generator so long as it can generate steam. For example, a method (referred to as a ‘pipe heating type’, hereinafter) in which a heater is directly installed at the girth of a water supply hose along which water is passes through to heat water, rather than housing water in a certain space, may be used.

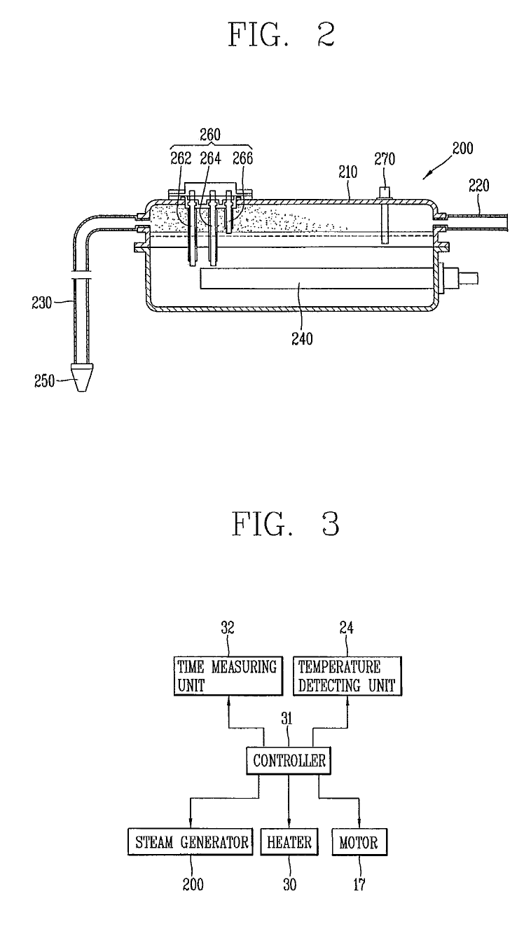

A controller 31 will now be described in detail with reference to FIG. 3.

At certain portions of the dryer according to an embodiment of the present invention, there are provided the controller 31 to control steam supply, hot wind supply and cooling, a time measuring unit 32 for measuring time of the steam supply, hot wind supply and cooling process, and a temperature detecting unit 24 for detecting temperature of hot wind exhausted from the drum 12.

The temperature detecting unit 24 is provided at a certain portion of the hot wind exhaust duct 14 and detects the temperature of hot wind exhausted via the hot wind exhaust duct 14. The time measuring unit 32 measures time during which steam generated by the steam generator 200 is supplied to the interior of the drum 12, time during which hot wind generated by the heater 30 is supplied to the interior of the drum 12, and time during which the dry item within the drum 12 is cooled. The controller 31 controls the operation of the dryer by controlling the heater 30, the steam generator 200, and the motor 17 based on information collected from each element of the dryer as described above including the detected temperature, the measured time, and the like.

The temperature detecting unit 24 detects the temperature of the hot wind exhausted from the drum 12. The controller 31 controls ON/OFF operation of the heater 30 according to a determination result as to whether or not the detected temperature is within a pre-set temperature range. The time measuring unit 32 measures time during which hot wind generated by the heater 30 is supplied to the interior of the drum 12. The controller 31 controls a processing procedure of the dry item based on the measured time or measured temperature or a pre-set time or temperature.

In this embodiment, the temperature detecting unit 24 is positioned at the hot wind exhaust duct 14, but it can be also provided at the hot wind guide duct 13 or the drum 12. The temperature detecting unit 24 may be provided at the inner side of the drum 12 to directly measure the temperature at the inner side of the drum 12.

If the temperature detecting unit 24 is a thermistor, a maximum value of the thermistor may be set as 68° C. and a delta value may be set as 4° C. Then, the temperature of hot wind exhausted by hot wind introduced into the drum 12 is gradually increased, and when it reaches 68° C., the thermistor operates to cut off power supply to the heater 30, turning off the heater 30. And then, with the heater turned off, when the temperature of the hot wind exhausted from the drum 12 is gradually lowered to reach 64° C., the thermistor in an off state operates to turn on the heater 30.

The dryer includes a control panel unit (not shown) provided at a certain portion of the cabinet to receive an operation method of the dryer according to a user selection. The controller operates the dryer in a sterilization mode or a refresh mode according to an operation method inputted from the control panel unit. Here, the sterilization mode operation is performed to supply hot wind to the interior of the drum to sterilize the dry item, and the refresh mode operation is performed to supply hot wind to the interior of the drum for a shorter time than that of the sterilization operation mode or at a lower temperature than that of the sterilization operation mode to remove rumples or creases of the dry item or deodorize the dry item.

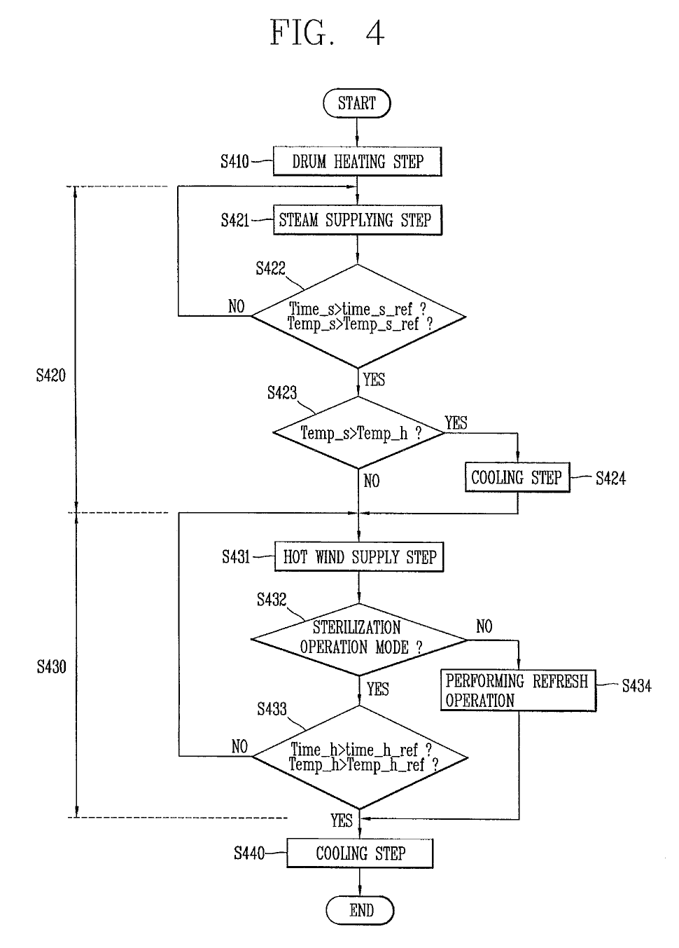

A dryer control method according to an embodiment of the present invention will now be described in detail with reference to FIGS. 4 to 6.

First, the dryer according to an embodiment of the present invention can perform a drying operation on a dry item such as clothes, the basic function of the general dryer, and controlling of the drying operation includes a hot wind supply process of supplying hot wind to the interior of the drum and a cooling process of lowering temperature inside the drum after the how wind supply process is terminated. This is common for the related art dryer, so its detailed description will be omitted.

The dryer control method according to an embodiment of the present invention includes: a steam supply step (S420) of supplying steam to the interior of a drum to sterilize a dry item housed in the drum and create a high temperature atmosphere; and a hot wind supply step (S430) of supplying hot wind to the interior of the drum to uniformly maintain the temperature at the interior of the drum.

Through this process of the dryer control method according to an embodiment of the present invention, the dryer can be operated to sterilize the dry item housed in the drum of the dryer without causing a thermal damage to the dry item (referred to as ‘sterilizing operation’, hereinafter). Here, the sterilizing operation can remove and prevent rumples or creases of the dry item.

A drum heating step S410 may be performed immediately before the steam supply step S420. In the drum heating step S410, the temperature difference of the interior of the drum between before and after steam supply in step S420. The reduced temperature difference is to prevent the temperature of steam supplied to the interior of the drum in the stem supply step S420 from being rapidly lowered.

In the step supply step S420, steam is supplied to the interior of the drum (S421) so that the temperature (Temp_s) of the interior of the drum can reach a high temperature (Temp_hi) within a shorter time than in the hot wind supply step S430). In addition, in the steam supply step S420, it is possible to control the temperature of the interior of the drum at the high temperature by such time, and it is also possible to control according to whether or not the temperature (Temp_s) of the interior of the drum has reached a reference temperature (Temp_s_ref) (S422).

The steam supply step S420 may be maintained at a higher temperature than that of the hot wind supply step S430 (S423). The cooling step S440 is added immediately after the steam supply step S420 in order to lower the temperature of the interior of the drum maintained in the steam supply step S420 to cool the dry item in the drum.

The stem supply step S420 is maintained at a lower temperature than that of the hot wind supply step S430 and can be controlled according to a comparison result between the steam supply time (Time_s) and the reference steam supply time (Time_s_ref) (S422). In this case, the steam supply time is maintained for a longer time in the steam supply step S420 than in the hot wind supply step S430 so that the temperature at the interior of the drum can rise up to a target temperature or in order to have a sufficient time for sterilizing the dry item. The steam supply step S420 is maintained at a temperature range of 60° C. or higher in order to spray steam for sterilization, and the hot wind supply step S430 is maintained at a particular temperature range for a certain time to perform sterilization with the supplied hot wind. The certain time may be at least 30 minutes.

The dryer control method may further include a step of inputting an operation mode of the dryer before the steam supply step. In this case, if the received dry operation method is a refresh method, rumples or creases of the dry items accommodated in the drum are removed or deodorized in the hot wind supply step (S434)

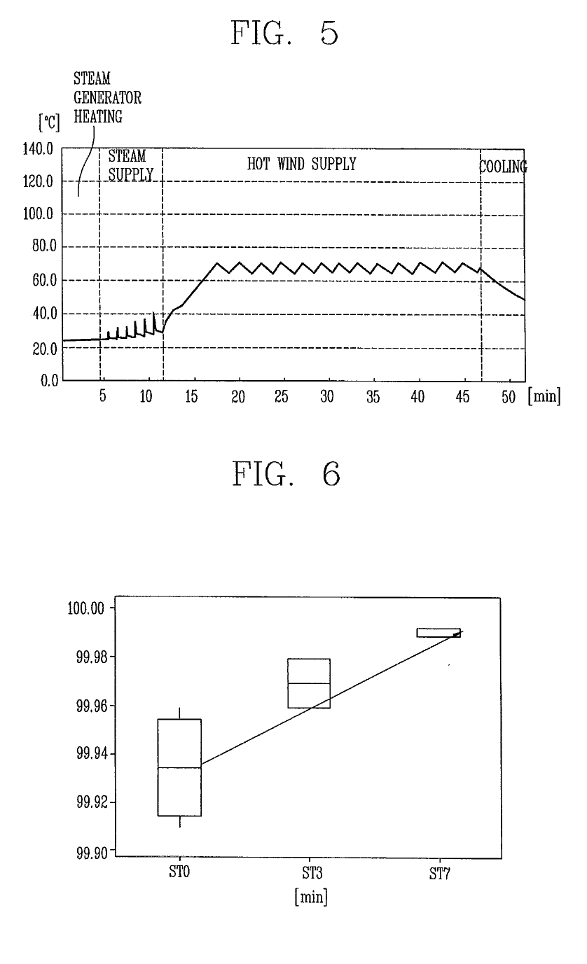

FIG. 5 is a graph of the relationship between time and temperature when the dryer control method is performed in a sterilization operation mode according to an embodiment of the present invention.

As described above, the dryer according to an embodiment of the present invention includes the container heating type steam generator 200, so time is required to heat the steam generator 200. As shown in FIG. 5, preferably, the hot wind supply step S430 is maintained for 35 minutes so that the temperature range of the interior of the drum can be maintained at between 64° C. to 68° C. As for the dryer control method according to an embodiment of the present invention, experimentation was performed with pseudomonas aeruginosa, staphylococcus, and K. pneumoniae existing in a dry item.

In the present invention, a target sterilization rate is set to sterilize 99.9% of the dry item based on the NSF of the United States. In the sterilization dryer according to an embodiment of the present invention, a temperature range for performing sterilization is set in consideration of microbiological characteristics, and the sterilization dryer is controlled at the most effective temperature according to the experimentation results. Namely, as the temperature gets higher, it is advantageous for sterilization, but the temperature is not allowed to go beyond a temperature range in case of dry-operating the dryer in consideration of the aspect of damage of cloth.

In the dryer control method according to an embodiment of the present invention, 60° C. or higher is maintained as a temperature suitable for sterilization, and in order to minimize damage of the dry item such as cloth and the like, the overall stroke time may be reduced and the operation of the dryer is controlled to maximize dry efficiency.

FIG. 6 is a graph of the relationship between a steam supply time and a sterilization rate of pseudomonas aeruginosa when the hot wind supply time is fixed as 15 minutes.

As shown in FIG. 6, when hot wind is supplied to the interior of the drum of the dryer to perform sterilization operation, if the hot wind supply time is the same, a sterilization rate is increased in proportion to the steam supply. Namely, the sterilization power is better when the steam supply step is performed together than the case where only the hot wind supply step is performed in the overall stroke time.

The device and method for controlling the dryer according to an embodiment of the present invention are based on the sterilization temperatures and sterilization time of each bacterium (germ). The pseudomonas aeruginosa was sterilized but the staphylococcus was not sterilized up to a target value only through the steam fresh operation proposed in the present invention.

However, the sterilization operation proposed in the present invention sterilized the staphylococcus up to its target value. For example, when the sterilization rate is 99.50% or higher under the experimentation conditions performed by the applicant of the present invention, the sterilization rate of the NSF standard experimentation of the United States is 99.99% or higher.

TABLE 1

| Total required time (min) | Dry items | Sterilization rate (%) |
|---|---|---|
| 45 minutes = steam | King comforter | 99.99 |
| supply (7 minutes) + hot | Baby comforter | 99.95 |
| wind supply (35 minutes) + | AHAM 31b | 99.78 |
| cooling (3 minutes) | pillow | 99.99 |

Table 1 shows that when the dryer performs the steam supply step, the hot wind supply step and cooling step for 45 minutes excluding the steam generator heating step of 5 minutes, the sterilization rates with respect to the pseudomonas aeruginosa, staphylococcus, and K. pneumoniae for all the four types of dry items are all higher than 99.5% in the experimentation, which correspond to the sterilization rate of 99.99% in the US NSF standard experimentation.

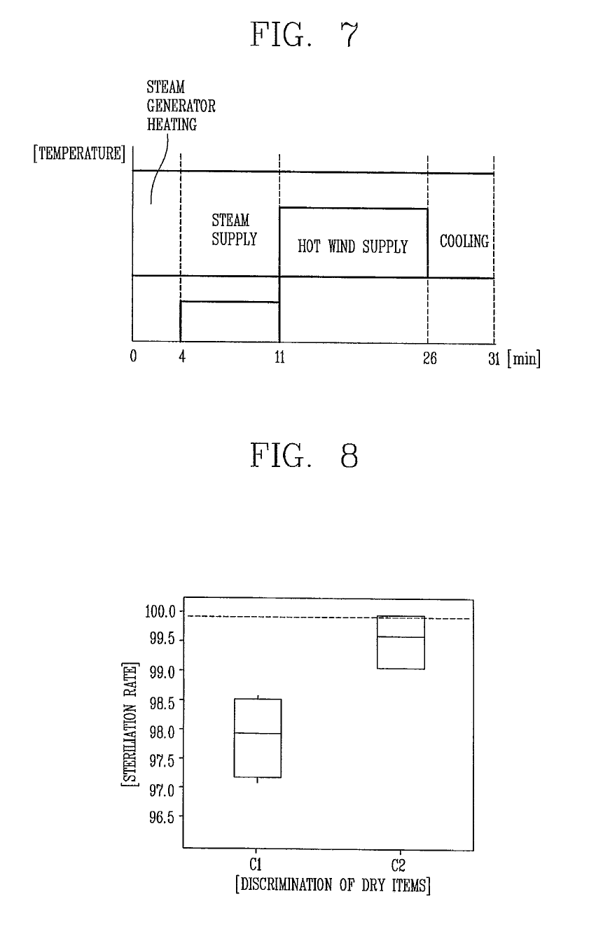

FIG. 7 is a graph of temperature over time when the hot wind supply process is performed for 15 minutes in the dryer control method according to an embodiment of the present invention, and FIG. 8 is a graph of the relationship between types of dry items and a sterilization rate when the dryer control method of FIG. 7 is performed on staphylococcus.

With reference to FIGS. 7 and 8, and Table 2, in case of staphylococcus, after the steam supply step was performed, the hot wind supply step was performed for 15 minutes. In this case, however, when the dry item was the pillow (C2), the target sterilization rate was obtained, but when the dry item was a mixture of AHAM 31b and denim (C1), the target sterilization rate failed to obtain.

TABLE 2
(the object bacterium is staphylococcus)

| Dry item | Sterilization rate (%) |
|---|---|
| AHAM 81b + Web denim | 99.99% |
| AHAM 81b + Dry denim | 100% |

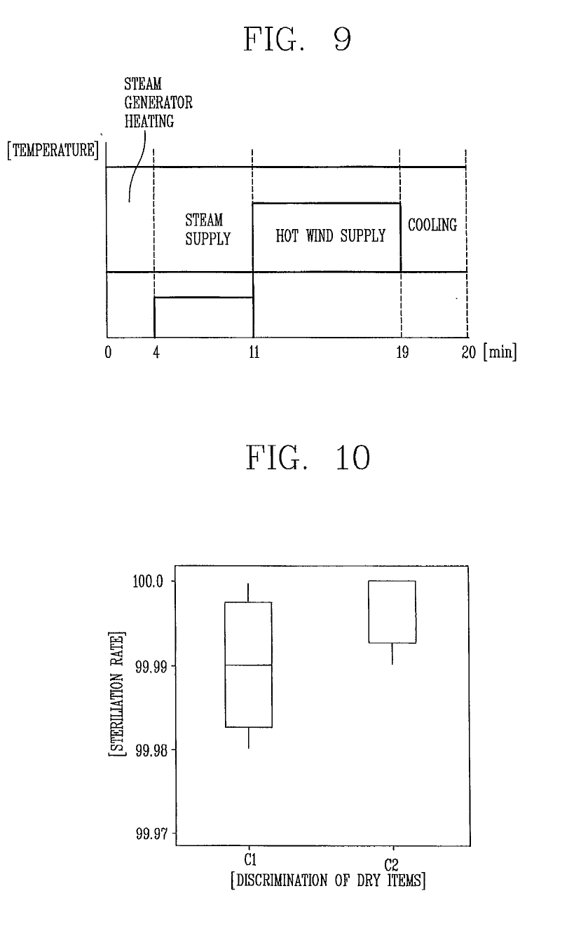

FIG. 9 is a graph of temperature over time when the hot wind supply process is performed for 8 minutes in the dryer control method according to an embodiment of the present invention, and FIG. 10 is a graph of the relationship between types of dry items and a sterilization rate when the dryer control method of FIG. 7 is performed on pseudomonas aeruginosa.

With reference to FIGS. 9 and 10 and Table 3, in case of pseudomonas aeruginosa, after the steam supply step was performed, the hot wind supply step was performed for 8 minutes. In both cases where the dry items were a mixture of AHAM 31b and denim (C1) and the pillow (C2), the target sterilization rate was obtained.

Namely, as shown in FIG. 6 and the Table 1, when the dryer performs the steam supply step for 7 minutes and the hot wind supply step for 35 minutes according to an embodiment of the present invention, the target bacteria were all sterilized with the target sterilization rate.

As so far described, the dryer and its control method according to the embodiments of the present invention have the following advantages.

That is, first, the dry items accommodated in the drum of the dryer can be sterilized without causing a thermal damage to the dry items, and the dry-completed dry items can be effectively prevented from being rumpled or creased

Second, the sterilization operation mode for sterilizing the dry items and removing creases of the dry items and the refresh operation mode for simply preventing or removing rumples or creases of the dry items effectively can be selectively operated according to a user selection.

Third, rumples or creases of the dry items such as clothes in an already dried state can be effectively removed without ironing.

As the present invention may be embodied in several forms without departing from the characteristics thereof, it should also be understood that the above-described embodiments are not limited by any of the details of the foregoing description, unless otherwise specified, but rather should be construed broadly within its scope as defined in the appended claims, and therefore all changes and modifications that fall within the metes and bounds of the claims, or equivalents of such metes and bounds are therefore intended to be embraced by the appended claims.

What is claimed is:

1. A method for controlling a dryer, the method comprising:
a steam supply step of supplying steam to the interior of a drum to create a high temperature atmosphere and sterilize a dry item housed in the drum; and
a hot wind supply step of supplying hot wind to the interior of the drum to uniformly maintain the temperature at the interior of the drum.

2. The method of claim 1, wherein the steam supply step reaches the high temperature within a shorter time than the hot wind supply step.

3. The method of claim 1, wherein the steam supply step is controlled according to the temperature at the interior of the drum.

4. The method of claim 1, wherein the steam supply step is maintained at a higher temperature than that of the hot wind supply step.

5. The method of claim 4, further comprising:
a cooling step of lowering the temperature maintained in the steam supply step immediately after the steam supply step.

6. The method of claim 1, wherein the steam supply step is maintained at a lower temperature than that of the hot wind supply step.

7. The method of claim 1, wherein the steam supply step is controlled according to a steam supply time.

8. The method of claim 1, wherein the steam supply step is temporally maintained for a longer time than the hot wind supply step.

9. The method of claim 1, wherein the steam supply step is maintained at a temperature band of 60° or higher.

10. The method of claim 1, wherein the hot wind supply step is maintained for a certain time at a particular temperature band.

11. The method of claim 10, wherein the certain time is at least 30 minutes.

12. The method of claim 11, wherein the hot wind supply step is maintained for 35 minutes so that a temperature band of the interior of the drum can be maintained between 64° C. and 68° C.

13. The method of claim 12, wherein, in the hot wind supply step, creases of the dry items accommodated within the drum is removed or the dry items is deodorized.

14. The method of claim 1, wherein the bacteria existing in the dry item includes pseudomonas aeruginosa, staphylococcus, and K. pneumoniae

15. The method of claim 1, further comprising:
a dryer operation mode input step before the steam supply step.

16. The method of claim 15, wherein, if an inputted dryer operation method is a refresh operation method, the hot wind supply step is performed to remove creases of the dry items accommodated within the drum or deodorize the dry items.

17. The method of claim 16, wherein the hot wind supply step is temporally shorter than or has a lower temperature band than a hot wind supply step for sterilizing the dry items.

18. The method of claim 1, further comprising:
a drum heating step of heating the drum immediately before the steam supply step.

19. A dryer including a drum and a heater supplying hot wind to the interior of the drum and being able to supply steam to the interior of the drum, the dryer comprising:
a controller that controls the steam supply to the interior of the drum to make the interior of the drum a high temperature atmosphere to sterilize a dry item housed in the interior of the drum and controls a hot wind supply to the interior of the drum to uniformly maintain the temperature in the interior of the drum.

20. The dryer of claim 19, wherein the steam supply is performed according to a container heating method or a pipe heating method.

21. The dryer of claim 19, further comprising:
a control panel unit that receives an operation method of the dryer according to a user selection.

22. The dryer of claim 21, wherein the controller operates the dryer in a sterilization mode or a refresh mode according to the inputted operation method.

23. The dryer of claim 21, wherein in the sterilization mode operation, hot wind is supplied to the interior of the drum to sterilize the dry item, and in the refresh mode operation, hot wind is supplied to the interior of the drum for a shorter time or at a lower temperature than in the sterilization operation mode in order to remove creases of the dry item or deodorize the dry item.
